(19) United States
(12) Patent Application Publication
(10) Pub. No.: US 2014/0089850 A1
(43) Pub. Date: Mar. 27, 2014

(54) Systems and Methods of Using Motion Control to Navigate Panoramas and Virtual Tours

(71) Applicant: TourWrist, Inc., San Francisco, CA (US)

(72) Inventors: Alexander I. Gorstan, San Francisco, CA (US); Charles Robert Armstrong, San Francisco, CA (US); Kang S. Lim, San Ramon, CA (US)

(21) Appl. No.: 13/934,079

(22) Filed: Jul. 2, 2013

Related U.S. Application Data
(60) Provisional application No. 61/704,487, filed on Sep. 22, 2012.

(51) Int. Cl. G06F 3/0487; G06F 3/0482

(52) U.S. Cl. CPC G06F 3/0487; G06F 3/0482
USPC 715/810; 715/863

(57) ABSTRACT

A mobile device is configured to teleshift from a first lateral viewing perspective to a second lateral viewing perspective of a virtual tour object. The mobile device includes a sensor, a processor and a display. The sensor detects a teleshifting motion of the mobile device caused by a user, and the processor determines if a magnitude of the teleshifting motion is greater than a threshold. If the magnitude of the teleshifting motion is greater than the threshold, then the display teleshifts by transitioning from a first lateral viewing perspective to a second lateral viewing perspective of the virtual tour.

### CROSS REFERENCE TO RELATED APPLICATION

This non-provisional application claims the benefit of provisional application no. 61/704,487 filed on Sep. 22, 2012, entitled “Systems and Methods of Using Motion Control to Navigate Panoramas and Virtual Tours”, which application and is incorporated herein in its entirety by this reference.

### BACKGROUND

The present invention relates to systems and methods for displaying supplemental panoramic data. More particularly, the present invention relates to offering, retrieving and presenting panoramas with supplemental data thereby enabling users to view enhanced panoramic images.

The increasing wideband capabilities of wide area networks and proliferation of smart devices has been accompanied by the increasing expectation of users to be able to experience viewing of panoramas in real-time with supplemental information on-demand. However, conventional techniques for storing and retrieving panoramas with supplemental data are generally unintuitive and/or cumbersome.

Further, in many viewing circumstances, it may be preferable for the user to control their viewing experience, for example, affecting which supplemental information is displayed, through physical movement of their mobile device.

It is therefore apparent that an urgent need exists for efficiently offering, retrieving and presenting panoramas with supplemental data thereby enabling users to view enhanced panoramic images with optional intuitive user motion controls.

### SUMMARY

To achieve the foregoing and in accordance with the present invention, systems and methods for displaying panoramas and virtual tours are provided. In particular the systems and methods for navigating panoramic menus and navigating virtual tours are provided.

In one embodiment, a mobile device is configured to teleshift from a first lateral viewing perspective to a second lateral viewing perspective of a virtual tour object. The mobile device includes a sensor, a processor and a display. The sensor is configured to detect a teleshifting motion of the mobile device caused by a user, and the processor is configured to determine if a magnitude of the teleshifting motion is greater than a threshold. If the magnitude of the teleshifting motion is greater than the threshold, then the display teleshifts by transitioning from a first lateral viewing perspective to a second lateral viewing perspective. The first lateral viewing perspective and the second video lateral viewing perspective may be adjacent lateral viewing perspectives of the virtual tour.

In some embodiments, the teleshifting includes teleturning from the first lateral viewing perspective to the second lateral viewing perspective located around an object of interest of the virtual tour.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1 and 2 are exemplary flow diagrams illustrating the selection, retrieval and presentation of panoramas with supplemental data in accordance with one embodiment of the present invention;

FIG. 3 is a mobile device screenshot with an exemplary menu of user selectable panoramic images for the embodiment of FIG. 1;

FIG. 4 is a mobile device screenshot with an exemplary menu of user selectable supplemental data for the embodiment of FIG. 1;

FIGS. 5 to 9 are screenshots of exemplary panoramas with and without supplemental data for the embodiment of FIG. 1;

FIG. 10 is a perspective view showing the three exemplary rotational axes for the mobile device of FIG. 3;

FIG. 11 is a front view illustrating the Y-axis rotation useful for navigational control of the mobile device of FIG. 3; and

FIG. 12 is a top view illustrating a plurality of exemplary user viewing perspectives associated with navigating virtual tours using the mobile device of FIG. 3.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

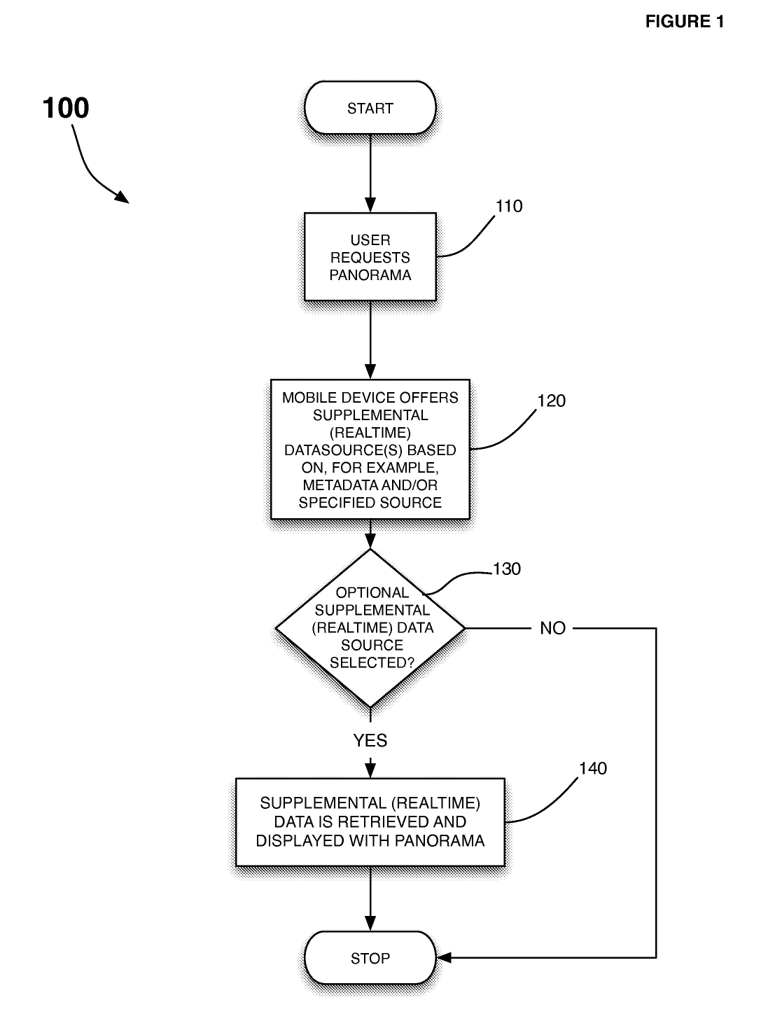

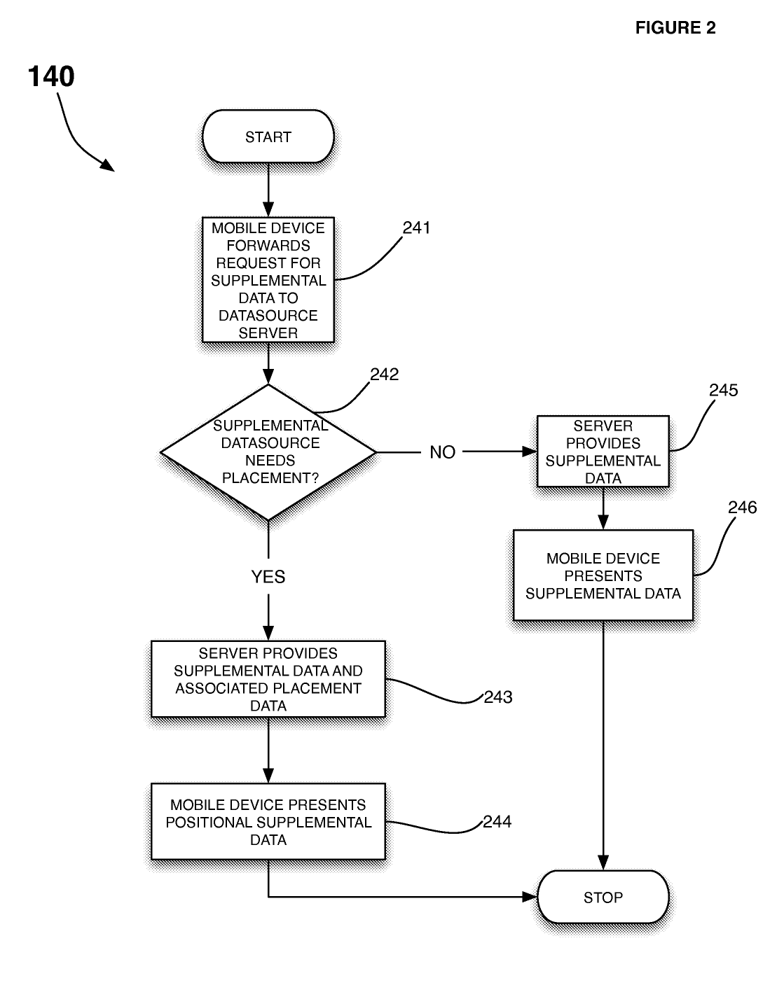

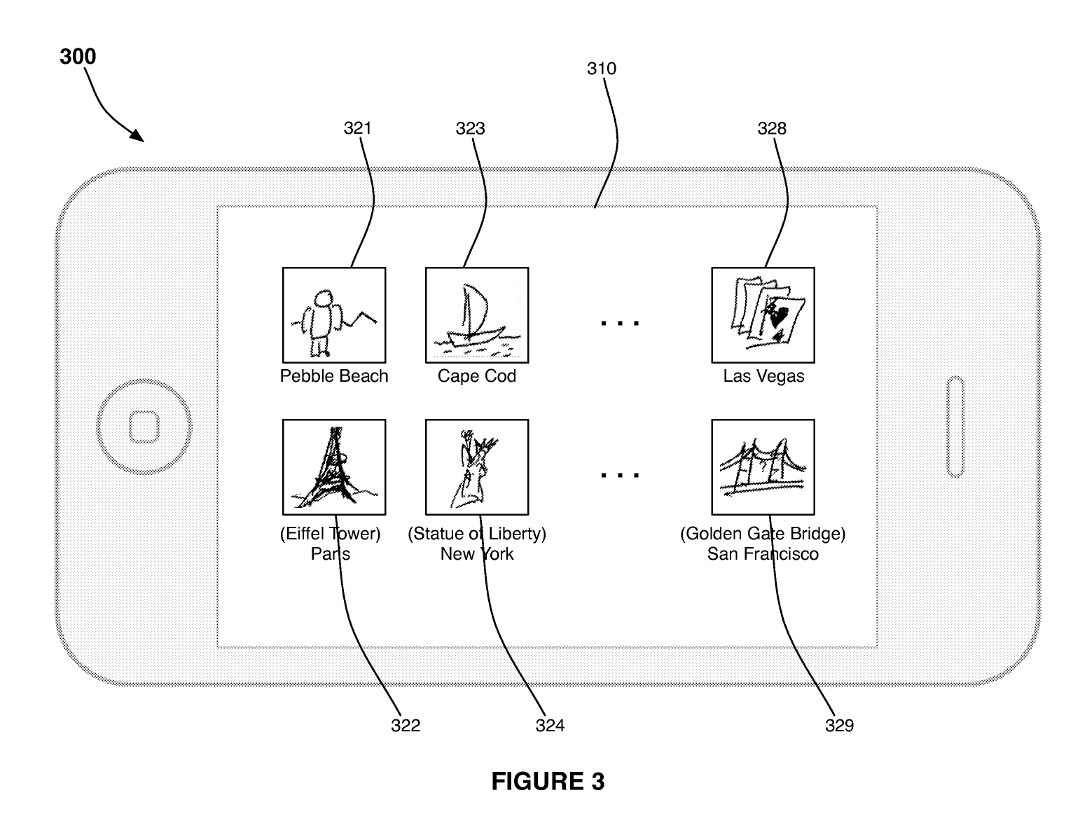

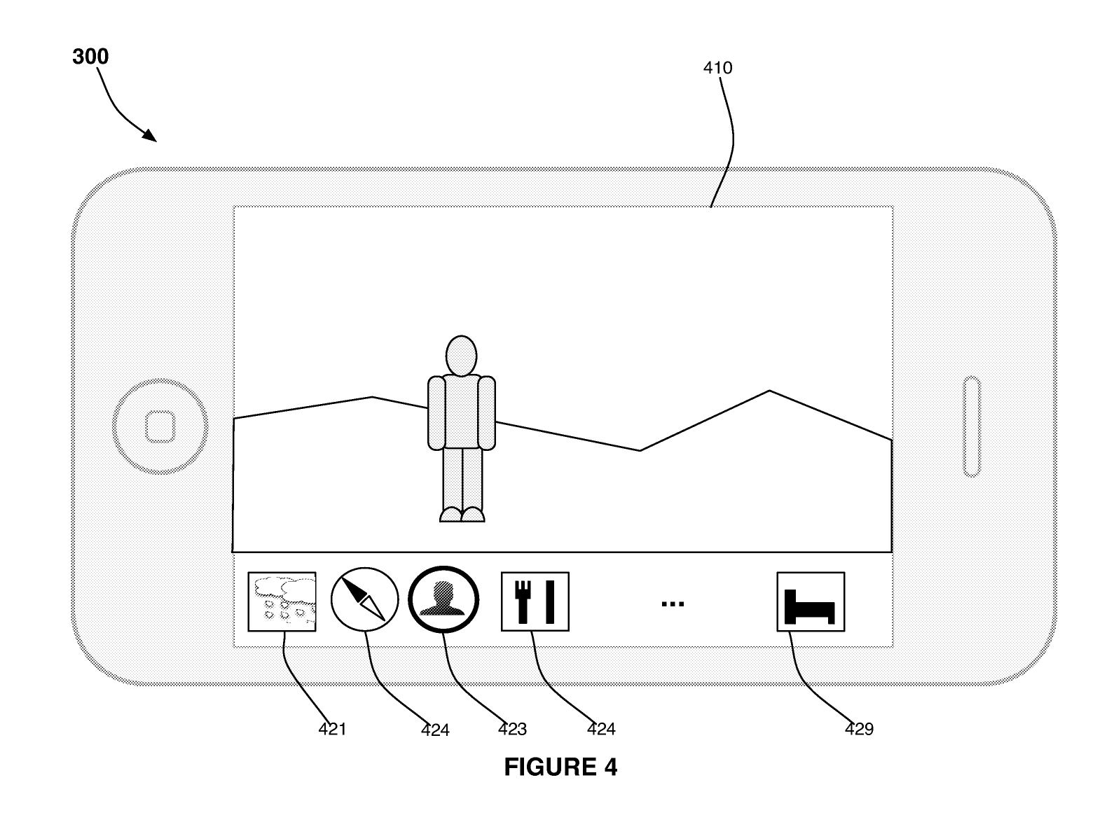

The present invention relates to systems and methods for offering, retrieving and presenting panoramas with optional supplemental data, and navigating the viewing experience with, for example, user motion controls. To facilitate discussion, FIGS. 1 and 2 are exemplary flow diagrams illustrating the selection, retrieval and presentation of panoramas with supplemental data for mobile devices in accordance with one embodiment of the present invention. FIG. 3 is a screenshot showing an exemplary menu of user selectable panoramic images for a mobile device 300, while FIG. 4 is a screenshot showing an exemplary menu of user selectable supplemental data for mobile device 300. Note that the term “mobile device” is used to describe a variety of portable electronic appliances including cellular phones, tablets, laptops and cameras. Note also that panoramic images (also referred to as panoramas) are used to describe a variety of images including both static and moving images and also virtual tours.

In this embodiment, mobile device 300 receives a user request for a panorama which may be selected by the user (not shown) from a customizable menu of choices as shown in FIG. 3 (step 110). As shown in the exemplary screenshot 310 of FIG. 3, mobile device 300 offers choices of panoramic icons, for example, geographical locations such as “Pebble Beach” 321, “Paris” 322, “Cape Cod” 323, “New York” 324 . . . “Las Vegas” 328 and “San Francisco” 329.

The mobile device 300 may respond to the panorama request by offering the user one or more customizable optional forms of supplemental data from menu (step 120). Supplemental data may be based on, for example, metadata such as visual data from the panorama itself or any objects or individuals displayed within the panorama, the known location of the environment shown in the panorama, the known weather at the location displayed within the panorama, the seasonal or daily time at which the panorama is being viewed, or personal data known to pertain to the user. In FIG. 4, exemplary screenshot 410 of mobile device 300 provides the user with a plurality of supplemental data choices such as “weather” 421, “geographical distance and/or direction” 422, “proximate contacts” 423, “favorite restaurants” 424 and “lodging choices” 429, described in greater detail below. Other examples of supplemental data include targeted messages including advertisements and/or announcements for products, services, and/or events.

In steps 130 and 140, if the user elects to display one or more supplemental data, then the mobile device 300 retrieves and displays the optional supplemental data together with the requested panorama.

Referring now to FIG. 2 which illustrated step 140 in greater detail, mobile device 300 sends a request for supplemental data, e.g., by sending reference metadata, to a (real-time) datasource server(s) via for example a wide area network such as the Internet (step 241). The datasource server(s) can be one or more of other mobile devices up to large stationary dedicated data storage facilities.

In step 242, if the requested supplemental data is associated with placement data, then the server provides both supplemental data and associated placement data to be presented by mobile device 300 to the user (steps 243, 244). Conversely, in step 242, if the requested supplemental data does not require placement, then the server provides supplemental data be presented by mobile device 300 to the user (steps 245, 246).

In some embodiments, the mobile device 300 is pre-loaded with and/or caches the supplemental data, and hence only requires periodic updates from the datasource server(s). It may also possible to share and update supplemental data amongst groups of users.

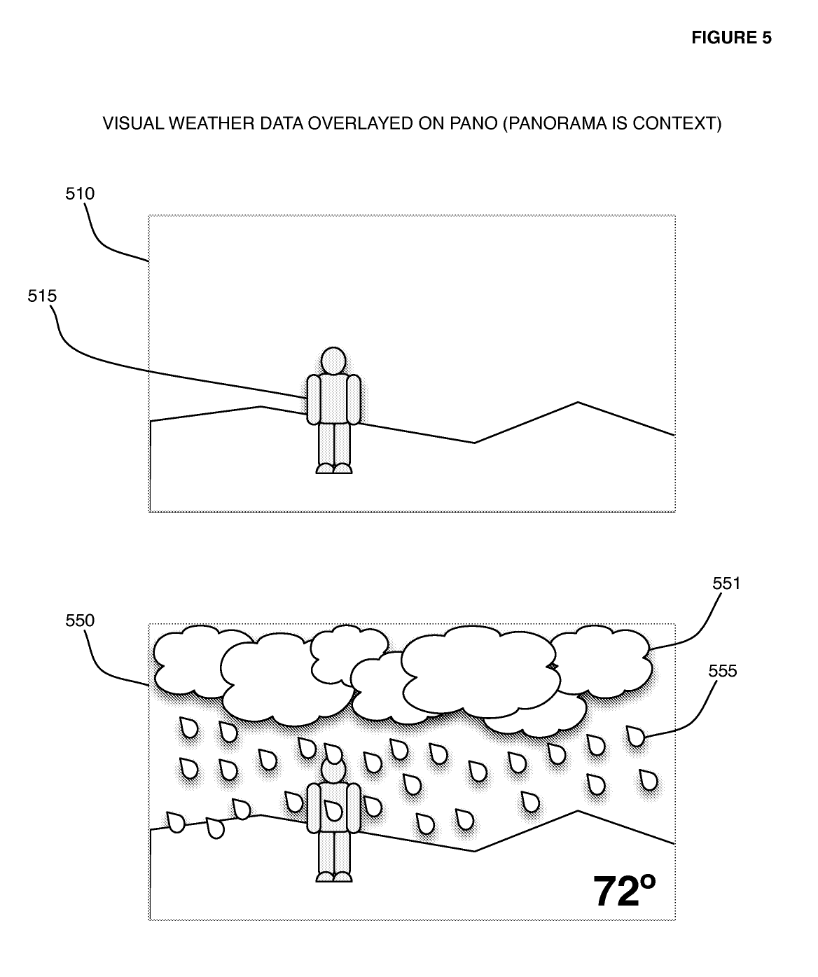

As discussed above and illustrated by the screenshot 550 of FIG. 5, if the user selects supplemental data choice 421 which is the “weather”, then the default current local weather may be overlaid onto the scenery of the original screenshot 510.

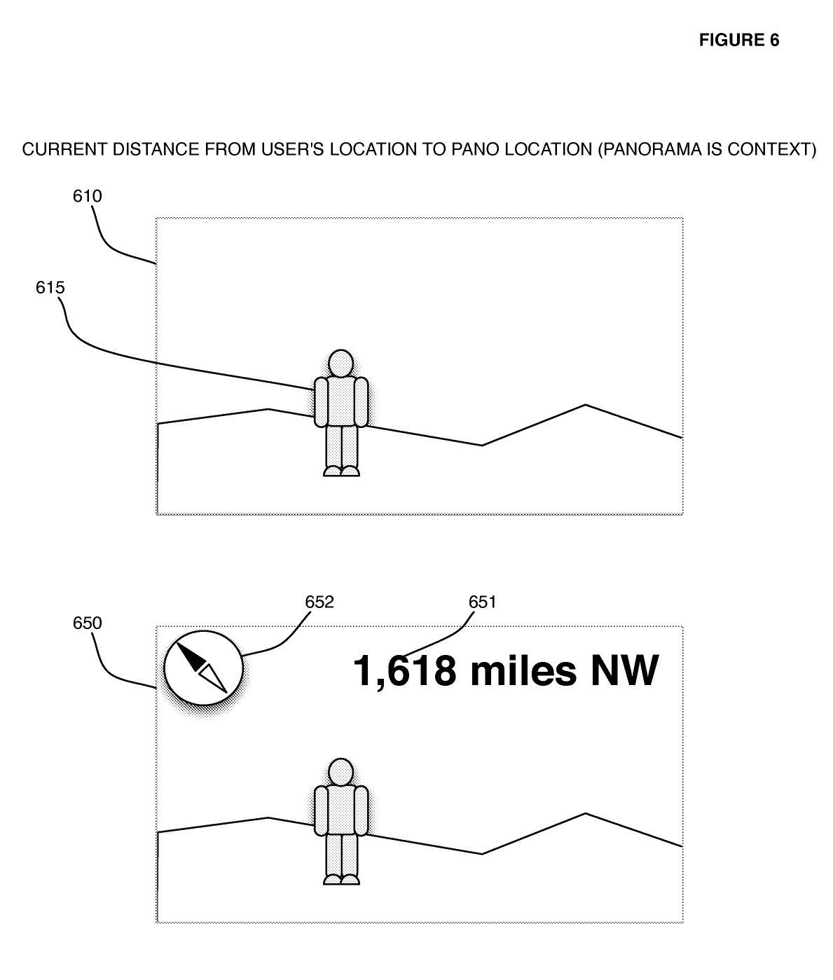

Supplemental geographical data may also be displayed as shown in screenshot 650 of FIG. 6, wherein the distance from the user's location is shown in the top right of the original scenery 610.

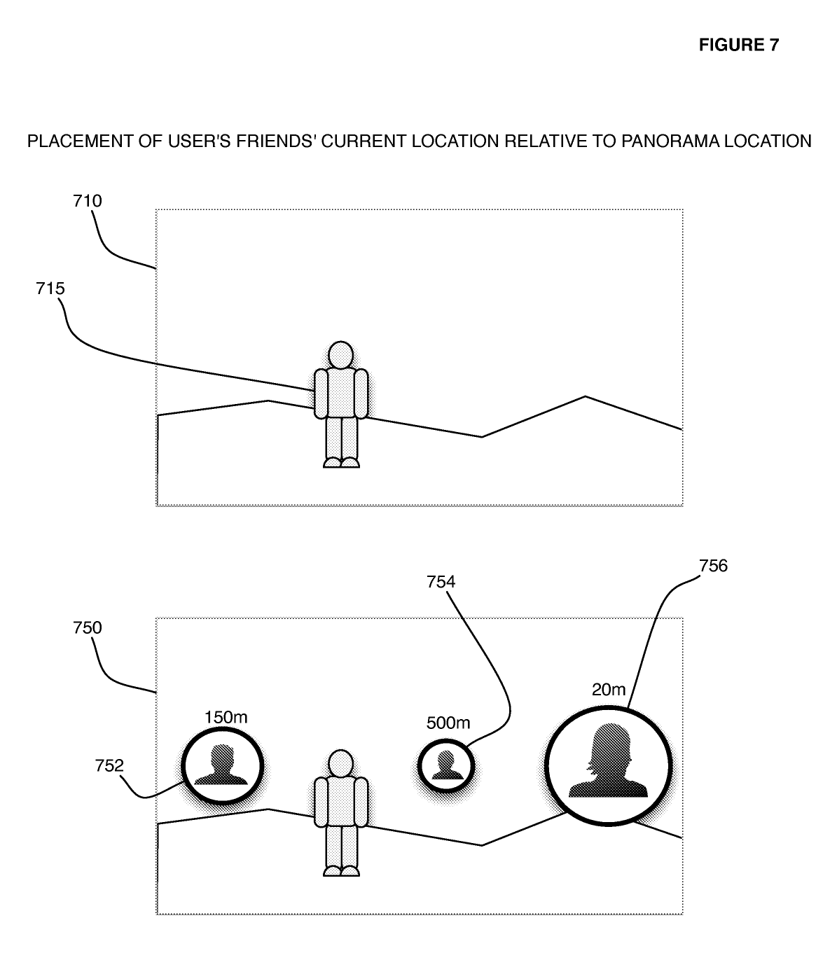

Referring now to the screenshot 750 of FIG. 7, it is also possible for the user to select the display of contact(s), such as friend(s), business associate(s) and/or favorite restaurant(s) or hotel(s) together with the original scenery 710. The server may also provide associated placement data for these contact(s) so that the contact(s) may be displayed proximate to their respective locations within the scenery. It is also possible for the server to provide mobile device 300 with contact information associated with these contacts for display.

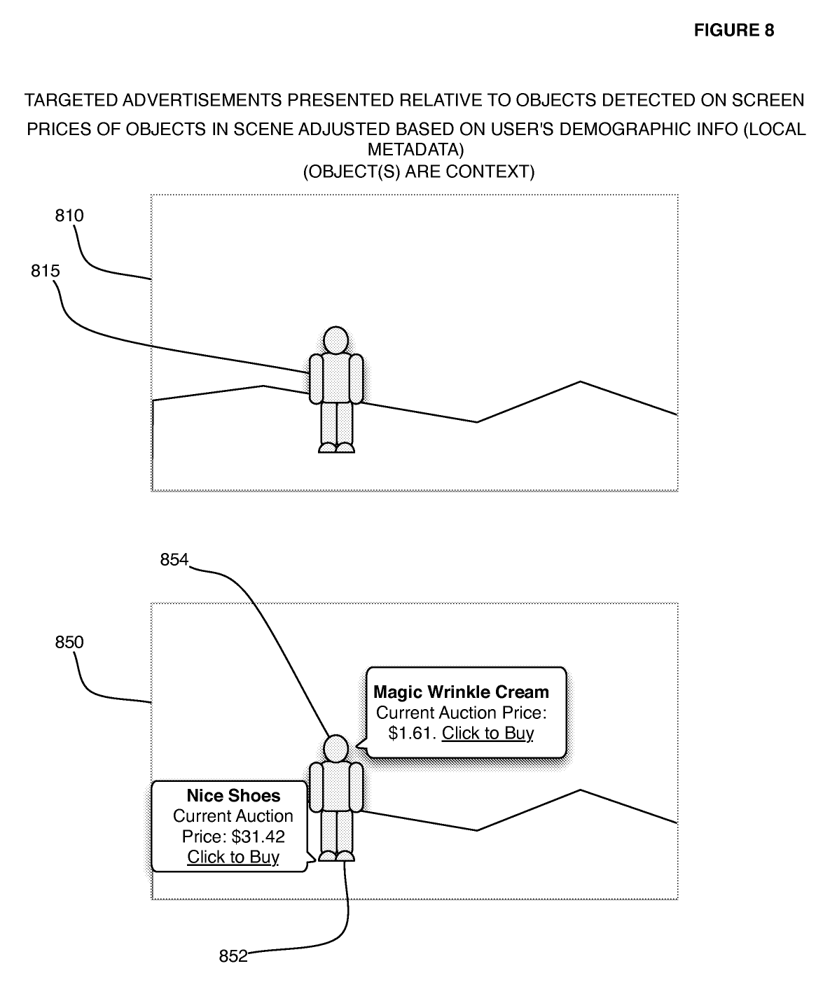

In the exemplary screenshot 850 of FIG. 8, targeted notices such as wrinkle cream advertisement 856 and/or shoe advertisement 858 may also be displayed together with the original scenery 810.

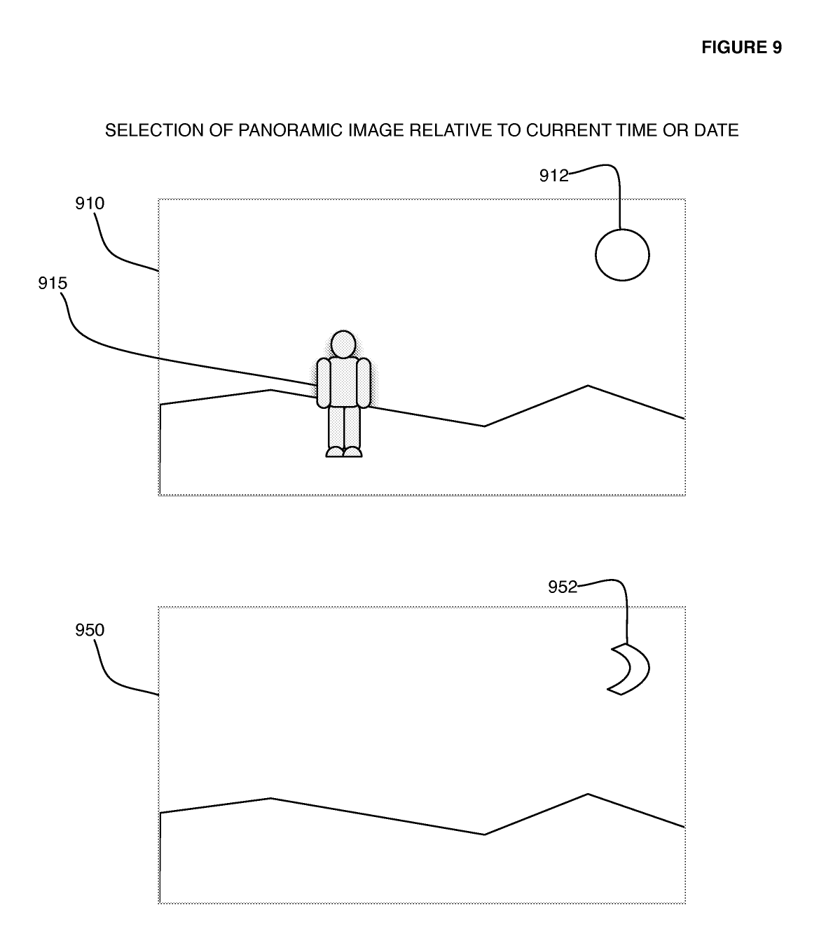

As exemplified by the daytime screenshot 910 and nighttime screenshot 950 of FIG. 9, supplemental data can include temporal data such as current date and/or time. Accordingly, a different panoramic image may be selected to correspond with the current or specified time and/or date.

In some embodiments, supplemental data choices may also be combined by the user. For example, choosing both “weather” 421 and “lodging” 429 may result in the overlaying of current weather and also lodging locations that have vacancies at the displayed geographic location.

Alternatively, if the user chooses “weather” 421 and “current time or season” (not shown), the resulting display on mobile device 300 may include temporal weather, i.e., the local weather at a specific season, date and/or time. Other exemplary combinations include hotel room availability and dinner reservation availability, and travel time estimates, each of which require an understanding of the location and date/time. In the case of travel time, other data sources such as weather and traffic conditions can also be combined.

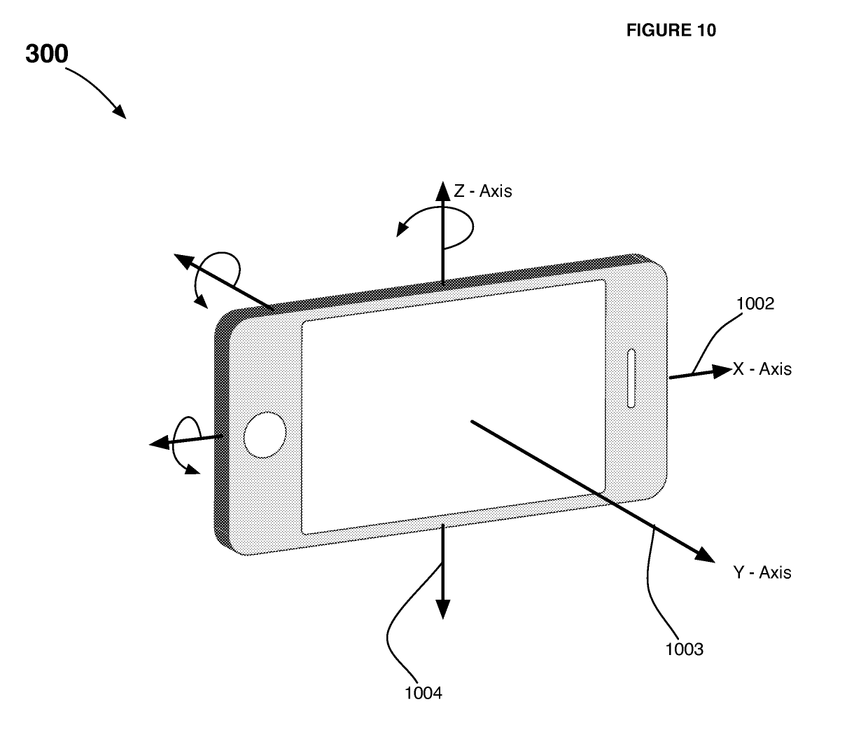

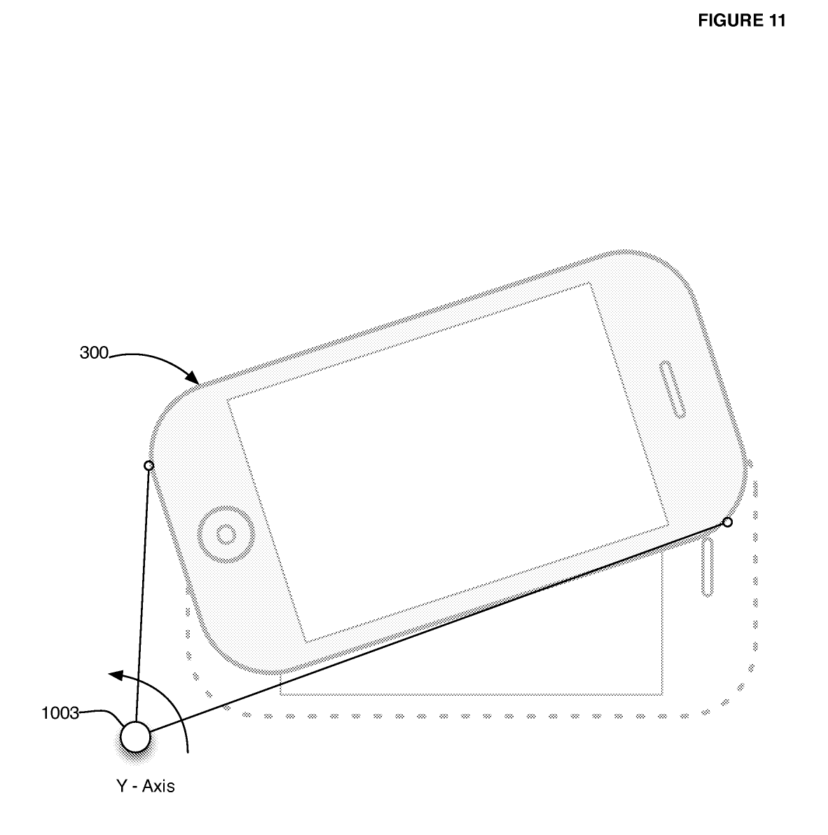

FIG. 10 is a perspective view showing the three exemplary rotational axes for the mobile device 300, while FIG. 11 is a front view illustrating the Y-Axis rotation useful for menu navigational control of the mobile device 300.

In some embodiments, mobile device 300 includes one or more accelerometer(s), magnetometer(s), gyroscope(s) and/or imaging sensor(s) (not shown) for measuring the angular rotations along the X-Axis 1002, Y-Axis 1003, and Z-Axis 1004. Suitable accelerometers, magnetometers, gyroscopes, and imaging sensors for mobile device 100 are commercially available from a variety of manufacturers including ST Electronics Ltd of Berkshire, United Kingdom, AKM Semiconductor Inc. of San Jose, California, InvenSense Inc. of Sunnyvale, California, and Sony Electronics of San Diego, California.

In order to enable the user's hand-held mobile device 300 to navigate the supplemental data menu without the need to use touch-screen or physical buttons of mobile device 300, translational planar and/or angular acceleration may be measured using, for example, the mobile device 300's accelerometer, magnetometer, gyroscope and/or image sensor.

Accordingly, rotational angular acceleration can be used as a menu navigational control of mobile device 300, namely, a quick rotation in the Y-Axis rotation 1003 to “flick” mobile device 300 in the “clockwise” or “counter-clockwise” axially. This somewhat “abrupt” rotation in the Y-Axis 1003 may be performed in a short, finite period of time to better discern the user's desire to flick mobile device 300, rather than a relatively slower rotation intended to, for example, adjusting the horizon of the scenery.

To successfully register a valid “clockwise” flick, mobile device 300 should for example achieve between approximately 20° to approximately 45° in relative Y-Axis rotation within approximately 500 milliseconds. Conversely, to successfully register a “counter-clockwise” flick, mobile device 100 should for example achieve between approximately −20° to approximately −45° in relative Y-Axis rotation within approximately 500 milliseconds.

In this embodiment as shown in FIG. 4, flicking “clockwise” causes the mobile device 300 to advance to the next menu choice to the “right” of the current menu choice. Conversely, flicking “counter-clockwise” causes the mobile device 300 to advance to the next menu choice to the “left” of the current menu choice. For example, a “clockwise” flick of mobile device 300 may cause mobile device 300 to transition from displaying the contact location(s) to displaying the dining choice(s), i.e., transition from icon 423 to icon 424.

The above described menu navigational control for mobile device 300 can be implemented in place of or in addition to a touchscreen based menu navigational control. It is also possible to use the above described Y-Axis flick(s) to scroll the menu choice(s) in combination with X-Axis flick(s) to select specific menu choice(s).

The above described detection of flicking motion(s) of mobile device 300, in one or more of the X-Axis, Y-Axis and/or Z-Axis, can also be used to navigate panoramas and/or virtual tours.

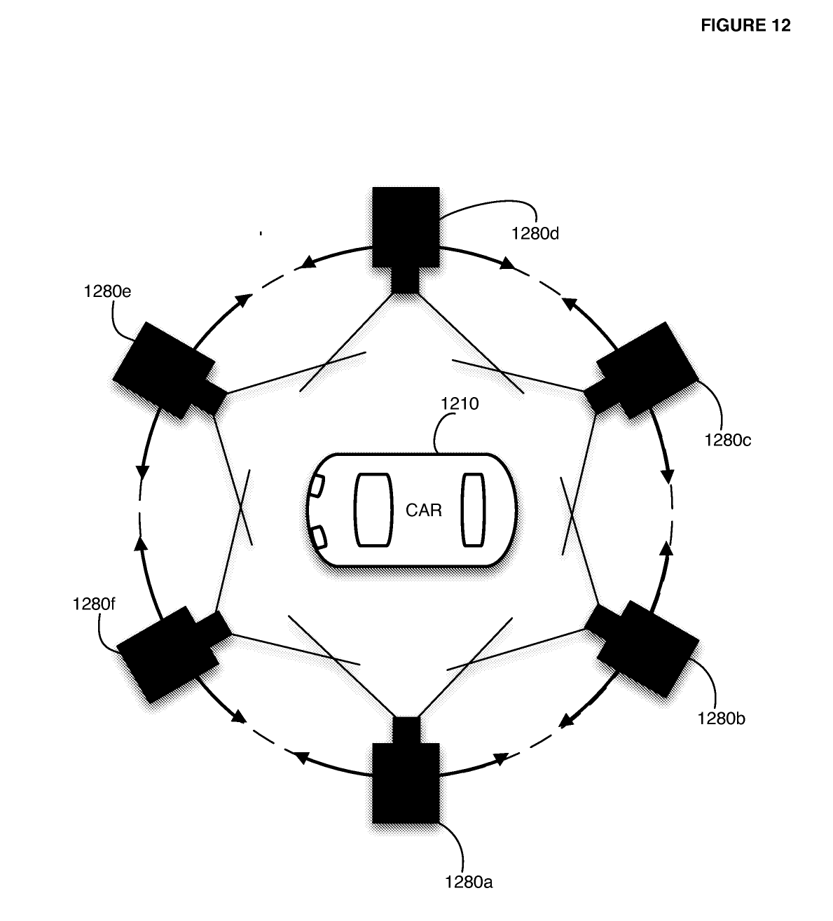

For example, as illustrated by FIG. 12, a top view illustrating a plurality of user viewing perspectives 1280a, 1280b, 1280c, 1280d, 1280e and 1280f, a user can use “right” flicks and/or “left” flicks of mobile device 300 in the Z-Axis, i.e., “teleshift” motions to laterally navigating during a virtual tour. In this example, teleshifting includes “teleturning” from a first lateral viewing perspective to a second lateral viewing perspective around an object of interest, e.g., from perspective 1280a to perspective 1280b positioned around car 1210.

In this exemplary embodiment, to successfully register a valid “right” flick, mobile device 300 should for example achieve between approximately 20° to approximately 45° in relative Z-Axis rotation within approximately 500 milliseconds. Conversely, to successfully register a “left” flick, mobile device 100 should for example achieve between approximately −20° to approximately −45° in relative Z-Axis rotation within approximately 500 milliseconds. Accordingly, the user viewing car 1210 can use a “right” flick to transition from viewing perspective 1280c to viewing perspective 1280d, and/or use a “left” flick to transition from viewing perspective 1280c to viewing perspective 1280b.

The user may also use double “right” or “left” flicks of mobile device 300 to continually view around car 1210 in the right or left directions, respectively. In this continually laterally “moving” viewing mode, a flick of mobile device 300 in the opposite direction can be used to freeze the user's viewing perspective.

It is also possible to use the above described Z-Axis flick(s) to laterally transition viewing perspective in combination with X-Axis flick(s) to cause the user's viewpoint to advance and/or to retreat. For example, a “forward” flick can be accomplished by quickly rotating the top of mobile device 300 away from the user, thereby causing the user viewpoint to advance from the exterior of car 1210 into the interior of car 1210. Conversely, a “backward” flick can be accomplished by quickly rotating the top of mobile device 300 toward the user, thereby causing the user viewpoint to retreat from the interior of car 1210 back to viewing the exterior of car 1210.

In sum, the present invention provides systems and methods for offering, retrieving and presenting panoramas with optional supplemental data. The advantages of such systems and methods include providing contextually relevant details which may not be readily apparent or available through panoramic imagery alone, more fully immersing a user in a panoramic environment, and allowing a user to affect their view or the data presented through more natural, tactile methods than afforded by conventional virtual or physical button pressing.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for teleshifting from a first lateral viewing perspective to a second lateral viewing perspective of a virtual tour object, the method useful in association with a mobile device configured to be hand-held by a user, the teleshifting method comprising:
detecting a teleshifting motion of a mobile device configured to conduct a virtual tour for a user;
evaluating a magnitude of the teleshifting motion; and
if the magnitude of the teleshifting motion is greater than a threshold, then teleshifting from a first lateral viewing perspective to a second lateral viewing perspective, and wherein the first lateral viewing perspective and the second lateral viewing perspective are adjacent lateral viewing perspectives of the virtual tour.

2. The teleshifting method of claim 1 wherein the first lateral viewing perspective and the second lateral viewing perspective are adjacent lateral viewing perspectives of a virtual tour object.

3. The teleshifting method of claim 2 wherein the teleshifting includes teleturning from the first lateral viewing perspective to the second lateral viewing perspective, and wherein the first lateral viewing perspective and the second lateral viewing perspective are both positioned around the virtual tour object.

4. The teleshifting method of claim 1 wherein the teleshifting motion includes a flick.

5. The teleshifting method of claim 4 wherein detecting the flick includes detecting angular acceleration along a substantially vertical axis of the mobile device.

6. The teleshifting method of claim 5 wherein the flick is one of a left flick and a right flick.

7. The teleshifting method of claim 1 wherein the teleshifting motion includes a double flick.

8. The teleshifting method of claim 7 wherein detecting the double flick includes detecting angular acceleration along a substantially vertical axis of the mobile device.

9. The teleshifting method of claim 8 wherein the double flick is one of a left double flick and a right double flick.

10. The teleshifting method of claim 1 wherein the threshold is user adjustable.

11. A mobile device configured to teleshift from a first lateral viewing perspective to a second lateral viewing perspective of a virtual tour object, the mobile device comprising:
a sensor configured to detect a teleshifting motion of the mobile device caused by a user;
a processor configured to determine if a magnitude of the teleshifting motion is greater than a threshold; and
a display configured to teleshift if the magnitude of the teleshifting motion is greater than the threshold, wherein the teleshifting causes the display to transition from a first lateral viewing perspective to a second lateral viewing perspective, and wherein the first lateral viewing perspective and the second video lateral viewing perspective are adjacent lateral viewing perspectives of the virtual tour.

12. The mobile device of claim 11 wherein the first lateral viewing perspective and the second lateral viewing perspective are adjacent lateral viewing perspectives of a virtual tour object.

13. The mobile device of claim 12 wherein the teleshifting includes teleturning from the first lateral viewing perspective to the second lateral viewing perspective, and wherein the first lateral viewing perspective and the second lateral viewing perspective are both positioned around the virtual tour object.

14. The mobile device of claim 11 wherein the teleshifting motion includes a flick.

15. The mobile device of claim 14 wherein detecting the flick includes detecting angular acceleration along a substantially vertical axis of the mobile device.

16. The mobile device of claim 15 wherein the flick is one of a left flick and a right flick.

17. The mobile device of claim 11 wherein the teleshifting motion includes a double flick.

18. The mobile device of claim 17 wherein detecting the double flick includes detecting angular acceleration along a substantially vertical axis of the mobile device.

19. The mobile device of claim 18 wherein the double flick is one of a left double flick and a right double flick.

20. The mobile device of claim 11 wherein the threshold is user adjustable.

21. A computerized method for navigating a menu of a panorama, useful in association with a mobile device configured to be handheld by a user, the method comprising:
detecting a flicking motion of a mobile device configured to navigate a supplemental panoramic data menu for a user, and wherein the flicking motion is substantially around an axis substantially perpendicular to a display of the mobile device; and
evaluating a magnitude and a direction of the flicking motion, wherein:
if the magnitude of the flicking motion is greater than a threshold and is clockwise, then traversing along a first direction of the menu; and
if the magnitude of the flicking motion is greater than a threshold and is counter-clockwise, then traversing along a second direction of the menu.

22. A mobile device configured to navigate a menu of a panorama, the mobile device comprising:
a sensor configured to detect a flicking motion of a user holding the mobile device, wherein the flicking motion is intended to navigate a supplemental panoramic data menu for the user, and wherein the flicking motion is substantially around an axis substantially perpendicular to a display of the mobile device; and
a processor configured to evaluate a magnitude and a direction of the flicking motion, wherein:
if the magnitude of the flicking motion is greater than a threshold and is clockwise, then traversing along a first direction of the menu; and
if the magnitude of the flicking motion is greater than a threshold and is counter-clockwise, then traversing along a second direction of the menu.
